(19) United States
(12) Patent Application Publication
(10) Pub. No.: US 2009/0153495 A1
(43) Pub. Date: Jun. 18, 2009

(54) INPUT METHOD FOR USE IN AN ELECTRONIC DEVICE HAVING A TOUCH-SENSITIVE SCREEN

(75) Inventors: Li-Hsuan CHEN, Taipei (TW); Bo-Ching CHIOU, Taipei (TW); Yu-Fang CHEN, Taipei (TW)

Correspondence Address: QUINTERO LAW OFFICE, PC, 2210 MAIN STREET, SUITE 200, SANTA MONICA, CA, 90405, US

(73) Assignee: WISTRON CORP., TAIPEI HSIEN (TW)

(21) Appl. No.: 12/128,218

(22) Filed: May 28, 2008

(30) Foreign Application Priority Data
Dec. 18, 2007 (TW) TW96148413

(51) Int. Cl. G06F 3/041

(52) U.S. Cl. 345/173

(57) ABSTRACT

An input method for use in an electronic device having a touch-sensitive screen is disclosed. The method comprises the following steps. An input signal is first received. Then, at least one control item corresponding to the specific program is displayed on the touch-sensitive screen in which the control item has a corresponding control area within the touch-sensitive screen. Next, it is determined whether a confirmation input signal inputted to the corresponding control area of the touch-sensitive screen is detected. A parameter of the control item is adjusted according to the confirmation input signal when the confirmation input signal has been detected.

### BACKGROUND OF THE INVENTION

1. Field of the Invention

The invention relates to electronic devices and related input methods, and more particularly, to input methods for use in an electronic device having a touch-sensitive screen.

2. Description of the Related Art

Driven by user requirements, more and more electronic devices, especially handheld or portable electronic devices such as smart phones, personal digital assists (PDAs), tablet PCs or Ultra Mobile PCs (UMPCs), comprise a touchable or touch-sensitive screen. The touchable or touch-sensitive screen can be directly touched by the user as one of the main input devices. Specifically, users operate the electronic device through a touch-and-select function, whereby one of the items or programs displayed on the touch-sensitive screen is controlled or performed by directly touching the item or program on the touch-sensitive screen. For example, a user may touch-and-select a button or an icon that represents a multimedia playing function to perform a multimedia playing program or touch-and-select a button or an icon that represents a GPS navigation function to perform a GPS related program.

For current touch-sensitive screens, one operation can be performed by directly selecting a target item representing the operation. A pointing device, such as a finger(s), a fingertip(s) or a stylus, is applied for touching and making selections on the touch-sensitive screen. That is, if a user desires to control an option or item, he/she has to precisely aim and touch the defined area of the option or item at the corresponding icon position on the displayed screen using the pointing device to inform the electronic device to perform the specified program. For example, if a user desires to adjust a volume or a channel of the electronic device, a control bar that has the icon or button which represent the volume and the channel control should be firstly opened or displayed and then the instructions for performing the required adjustment would be sent to the electronic device by aiming or touching the displayed screen at the corresponding icon or button displayed on the control bar. For some frequently used programs, such as a multimedia playing program, the aforementioned method does not allow immediate access to some commonly adjusted multimedia playing program items, such as volume control, channel selection control or the like which hinders the overall entertainment effect of the electronic device and makes the multimedia playing process less efficient.

Particularly, if the electronic device is utilized under some special circumstance, such as while operating a moving vehicle, a user will be required to transfer a part of his/her operating attention, to the electronic device to perform the aforementioned operations, which causes user inconvenience and influences driving safety.

### BRIEF SUMMARY OF THE INVENTION

A simple control method for use in an electronic device having a touch-sensitive screen is provided to overcome the aforementioned problems for users, so as to improve convenience in use and control of the electronic device.

An embodiment of an input method for use in an electronic device having a touch-sensitive screen is provided. The method comprises the following steps. An input signal is first received. At least one control item is displayed on the touch-sensitive screen in which the control item has a corresponding control area within the touch-sensitive screen. Then, it is detected whether a confirmation input signal has been inputted to the corresponding control area of the touch-sensitive screen. A parameter of the control item is adjusted according to the confirmation input signal when the confirmation input signal has been detected.

An embodiment of an electronic device is also provided. The electronic device comprises a touch-sensitive screen, a detection unit and a processing unit. The touch-sensitive screen is operable in a first mode for displaying a control screen having at least one control item thereon in which the control item has a corresponding control area within the control screen. The detection unit detects whether a pointing device is touched to the touch-sensitive screen and detects the interaction between the pointing device and the corresponding control area. When an input signal inputted to the touch-sensitive screen is detected by the detection unit, the processing unit adjusts a parameter of the control item according to the input signal and an interaction signal of the corresponding control area detected by the detection unit.

Another embodiment of an input method for use in an electronic device having a touch-sensitive screen is further provided. The method comprises the following steps. A control screen is provided in which the control screen has a plurality of control items each having a corresponding control area within the control screen. It is then detected whether an input signal of a first control area corresponding to a first control item has been inputted. Next, an attribute of the input signal is determined and a parameter of the first control item is accordingly adjusted.

### BRIEF DESCRIPTION OF THE DRAWINGS

The invention can be more fully understood by reading the subsequent detailed description and examples with reference to the accompanying drawings, wherein:

FIG. 1 is a block diagram of an embodiment of an electronic device according to the invention;

FIG. 2 is a flowchart illustrating an embodiment of an input method according to the invention;

FIG. 3 is a flowchart illustrating another embodiment of an input method according to the invention;

FIGS. 4A and 4B are lookup tables illustrating an interaction signal between the pointing device and touched control area and corresponding represented instructions according to an embodiment of the invention;

FIGS. 5A and 5B are schematics illustrating embodiments for signal inputting according to the invention; and

FIGS. 6A to 6C are schematics illustrating embodiments of volume control before and after volume adjusting according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

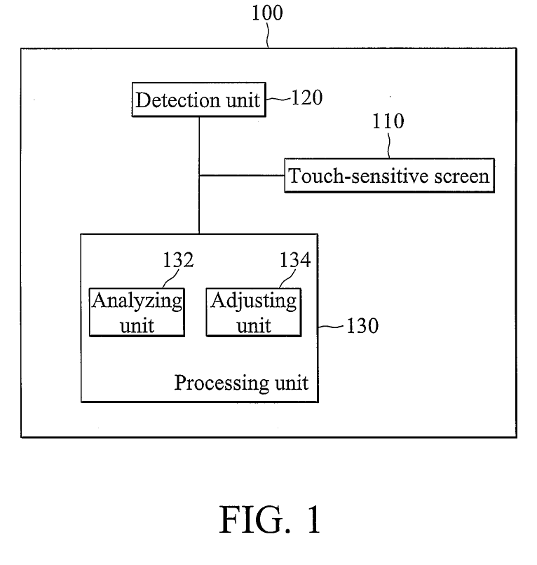

The invention is described with reference to FIGS. 1 through 6C, which generally relates to an electronic device and related input method for adjusting a parameter of the control items that are provided on the screen. In the following detailed description, reference is made to the accompanying drawings which from a part hereof, shown by way of illustration of specific embodiments. These embodiments are described in sufficient detail to enable those skilled in the art to practice the invention, and it is to be understood that other embodiments may be utilized and that structural, logical and electrical changes may be made, without departing from the spirit and scope of the invention. The following detailed description is, therefore, not to be taken in a limiting sense. It should be understood that many of the elements described and illustrated throughout the specification are functional in nature and may be embodied in one or more physical entities or may take other forms beyond those described or depicted.

Embodiments of the invention provide an input method for use in an electronic device, such as smart phone, personal digital assist (PDA), tablet PC or Ultra Mobile PC (UMPC), having a touchable or touch-sensitive screen. The touch-sensitive screen may be, for example, a multi-touch panel or a pressure-sensitive touch panel, wherein the pressure-sensitive touch panel can distinguish whether a touched force is pressed lightly or heavily. The touch-sensitive screen can be touched to generate at least one input signal such that a control unit can determine the manner in which the touch-sensitive screen is touched, according to the generated input signal and convert the detected touched behavior into a corresponding instructions for controlling or adjusting parameters of the specific functionality of the electronic device using the predefined rule.

The embodiments provide a strategy for solving the aforementioned conventional problems described when controlling or adjusting parameters of a specific functionality of the electronic device. In the embodiments, while performing a specific function, such as executing a multimedia playing program, a control screen having at least one control item is provided on the touch-sensitive screen, and users are capable of sending instructions for controlling or adjusting parameters of a control item by an interaction signal (e.g. number of touched finger(s) or touched force(s)) generated by touching a control area corresponding to the control item to be adjusted on the screen using the pointing devices such as a finger(s), a fingertip(s) or a stylus, so as to adjust parameters corresponding thereto.

FIG. 1 shows a block diagram of an embodiment of an electronic device 100 according to the invention. The electronic device 100 at least comprises a touch-sensitive screen 110, a detection unit 120 and a processing unit 130. The electronic device 100 may be, for example, any kind of handheld electronic device such as smart phones, personal digital assists (PDAs) or handheld computer systems, or any multimedia player that allows a user to control the function of the devices by touching and selecting control items from a touch-sensitive screen.

The touch-sensitive screen 110 is capable of providing display of control items, for example, displaying a screen comprising at least one control item for multimedia playing, such that users can perform the multimedia playing by touching and selecting the control item on the touch-sensitive screen 110. The touch-sensitive screen may be, for example, a multi-touch panel or a pressure-sensitive touch panel, wherein the pressure-sensitive touch panel can distinguish whether the touched force is a light or heavy pressed force, but it is not limited thereto. The multi-touch panel allows a user to input instructions by one or more than one finger, while the pressure-sensitive touch panel only allows a user to input instructions by one finger. The pressure-sensitive touch panel, however, allows users to input instructions by pressing lightly or pressing heavily with a single finger on the touch panel.

In this embodiment, while performing a specific program, the touch-sensitive screen 110 can be operated in a finger-touched mode such that related parameters of control items can be adjusted by sending instructions to the electronic device 100 using a predefined input manner. The control items may be, but are not limited thereto, such items as a volume control, a brightness control, a channel selection control, a speed control for a display or a switch control of a displaying device. Therefore, related parameters of the control items may be adjusted, by adjusting the value or increasing/decreasing the parameter of the selected control item. For example, if the control item to be adjusted is volume control, the value of the volume can be adjusted using a predefined input manner. The method for adjusting a parameter of a related control item using a predefined input manner is detailed.

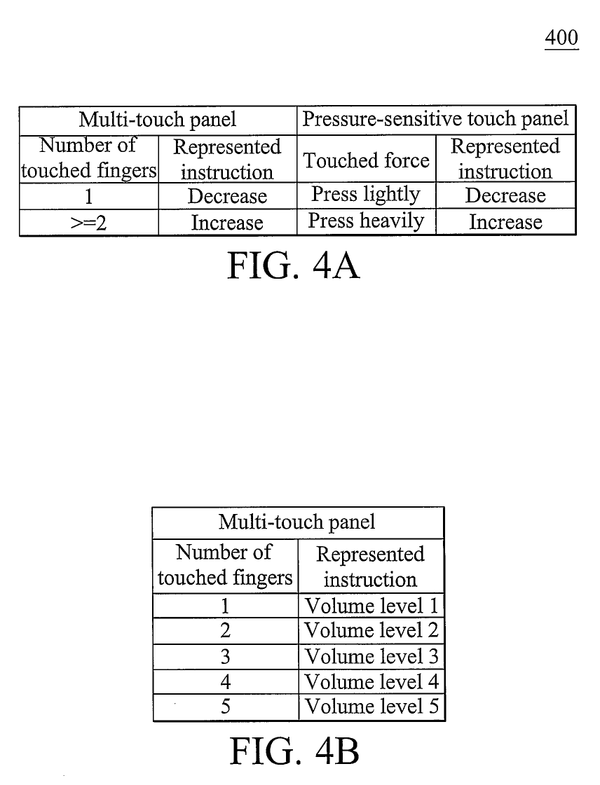

The detection unit 120 is used for detecting whether the touch-sensitive screen 110 is touched by a pointing device and providing information about a touched area and the manner in which the touched area is touched. The pointing device may be any device capable of touching the touch-sensitive screen 110 such as a finger(s), a fingertip(s) or a stylus. For example, the detection unit 120 will continually detect whether the touch-sensitive screen 110 has been touched by any finger or fingertip and send a message to notify the processing unit 130 in response to a detected touch by a finger(s) or a fingertip(s). Note that information about the touched area and the manner it is touched will also be provided to the processing unit 130 by the detection unit 120 if the touch-sensitive screen 110 is operated in the finger-touched mode. After receiving the information, the processing unit 130 is capable of adjusting parameter of the control item corresponding to the touched control area according to an interaction signal generated by interaction between the finger(s) and the touched control area detected by the detection unit 120. The interaction signals between the finger(s) and the touched control area are detailed below with reference to FIGS. 4A-4B.

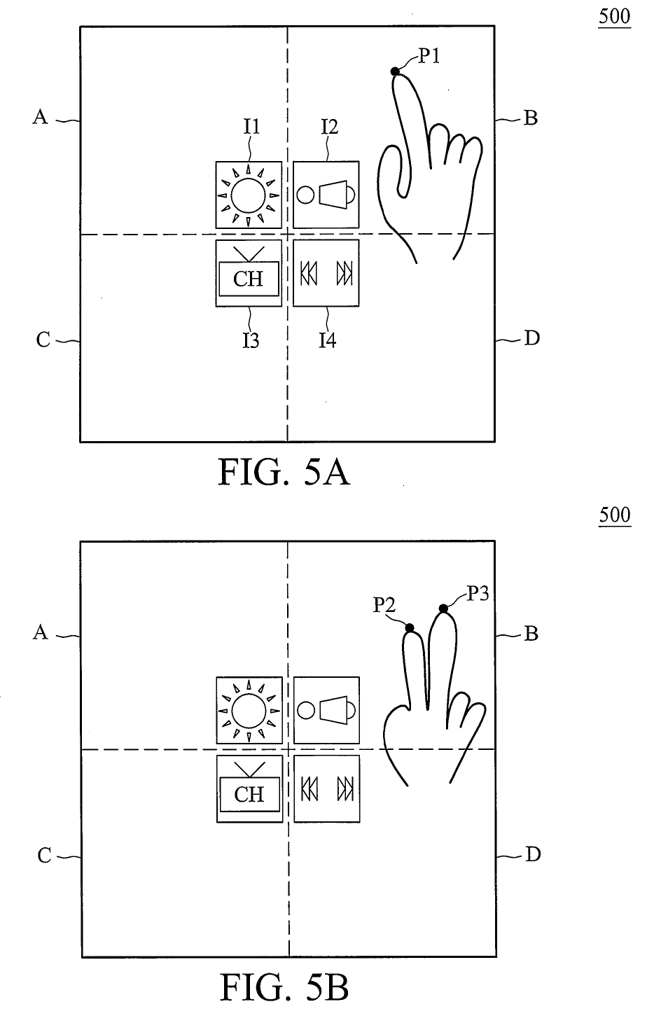

The processing unit 130 may further comprise an analyzing unit 132 and an adjusting unit 134. The analyzing unit 132 is used for analyzing the interaction between the finger(s) and touched control area to generate an interaction signal and convert the interaction signal to an adjustment signal for adjusting the parameter of the control item based on a predefined rule. The adjusting unit 134 then adjusts the parameter of the control item corresponding to the touched control area according to the adjustment signal generated by the analyzing unit 132. It is to be noted that the number of the control items correspond to the number of the programs which are in operation. Following describes how the parameter of the control item corresponding to the touched control area is adjusted, in accordance with the adjustment signal generated by the analyzing unit 132, with reference to FIGS. 5A-5B.

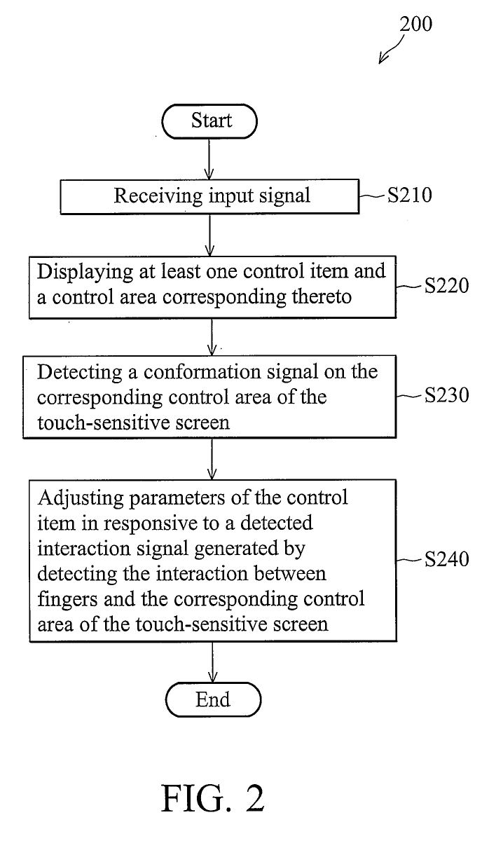

FIG. 2 is a flowchart 200 illustrating an embodiment of an input method according to the invention. First, a user adjusts parameters of some control items for a specific program by touching the screen of the touch-sensitive screen 110 to generate an input signal. In step S210, the detection unit 120 detects or receives the input signal and switches the touch-sensitive screen 110 to a finger-touched mode. In step S220, the touch-sensitive screen 110 is touched such that at least one control item corresponding to the specific program is displayed, whereby the control item has a corresponding control area on the touch-sensitive screen 110.

Referring to FIG. 5A, FIG. 5A comprises a control screen 500 according to an embodiment of the invention. The control screen 500 is divided into four control areas A-D in which each control area has a corresponding control item indicator for indicating to the user the meaning of a control item corresponding to the control area. For example, control area A has an indicator I1 indicating control item “Brightness” for brightness control, control area B has an indicator I2 indicating control item “Volume” for volume control, control area C has an indicator I3 indicating control item “Channel” for channel selection control (i.e. increase/decrease selected channel) and control area D has an indicator I4 indicating control item “Speed control for display” for controlling the display speed.

While attempting to adjust parameters of one of the control items, a user may input related instructions by touching any position within the control area corresponding to the control item to be adjusted using his finger(s) or fingertip(s). For example, a user may touch a position within the control area B with two fingers to send a instruction to increase the volume level, if he/she wants to increase the volume level as shown in FIG. 5B.

In step S230, the detection unit 120 detects whether a conformation input signal has been presented on the corresponding control area of the touch-sensitive screen 110. The detection unit 120 may determine whether a conformation input signal has been presented by detecting the interaction between the finger(s) and the control area corresponding to the control item and sending the detected result to the processing unit 130. A user may input a confirmation input signal by pressing the finger(s) on the corresponding control area of the control item. If a conformation input signal has been detected, in step S240, the processing unit 130 adjusts parameters of the control item according to the detected interaction signal generated by detecting the interaction between finger(s) and the corresponding control area of the control item. Accordingly, the analyzing unit 132 of the processing unit 130 analyzes the interaction signal generated by detecting the interaction between finger(s) and the corresponding control area of the control item and converts the analyzed result to an adjusting instructions based on a predefined rule. The adjusting unit 134 of the processing unit 130 then adjusts the parameter of the selected control item according to the adjusting instructions converted by the analyzing unit 132.

FIGS. 4A and 4B are lookup tables showing interaction signals generated by detecting the interaction between the pointing device and touched control area and corresponding represented instructions according to an embodiment of the invention. The Figs. illustrate how an interaction signal is converted to a corresponding instructions based on the predefined rule.

As shown in FIGS. 4A, possible interaction signals and represented instructions corresponding thereto for the touch-sensitive screen 110 utilizing a multi-touch panel or a pressure-sensitive touch panel are listed in a lookup table 400. When the touch-sensitive screen 110 type, is a multi-touch panel, the number of touched fingers can be detected to send an adjusting instructions. If A detection of the number of touched fingers is one (i.e. the touch-sensitive screen 110 is touched with a single finger), a instructions for decreasing the parameter of the control item is represented. Meanwhile, if a detection of the number of touched fingers is two or more (i.e. the touch-sensitive screen 110 is touched with two fingers or more than two fingers), a instructions for increasing the parameter of the control item is represented. Therefore, a user may intuitively decrease or increase related attribute value of the parameter by touching the touch-sensitive screen 110 with a single finger or more than one finger, respectively.

When the touch-sensitive screen type 110 is a pressure-sensitive touch panel, the touched force of the touched finger(s) can be detected to send an adjusting instructions. If A detection of the force of the touched finger is lightly pressed (i.e. the touch-sensitive screen 110 is touched with a light force), a instructions for decreasing the parameter of the control item is represented. Meanwhile, if a detection of the force of touched finger is heavily pressed (i.e. the touch-sensitive screen 110 is touched with a heavy force), a instructions for increasing the parameter of the control item is represented. Therefore, a user may intuitively decrease or increase related attribute values of the parameter by touching he/she touch-sensitive screen 110 with a lightly or heavily pressed force, respectively.

For example, if the control item to be adjusted is the control item “Volume”, the related attribute value of the parameter thereof is the level of the volume. A user can touch the corresponding control area with a single finger to send a instructions for decreasing the level of the volume, if the level of the volume is desired to be decreased or he/she can touch the corresponding control area with two fingers to send a instructions for increasing the level of the volume, if the level of the volume is desired to be increased.

In addition, when a multi-touch panel is utilized as the touch-sensitive screen 110, in addition to the input instructions for decreasing or increasing the value of the parameter by touching the touch-sensitive screen 110 with a single or multiple fingers respectively, the number of fingers can also be utilized to identify particular parameter adjustment instructions.

For example, as shown in FIG. 4B, if the number of fingers detected are one, two, three, four and five (i.e. a different number of fingers are used by the user), instructions for respectively adjusting the volume to level 1, level 2, level 3, level 4 and level 5 (maximum volume) are represented. Therefore, a user is capable of intuitively setting related attribute values of a parameter to be adjusted by touching with a corresponding number of fingers in response to a target value of the adjusted parameter. For example, a user may intuitively touch the screen 110 with three fingers to send instructions for adjusting the volume level to level 3, if level 3 of the volume is the desired volume.

It is to be understood that, for illustrative purposes, it is assumed that a PDA is utilized as the electronic device 100, a multi-touch panel is utilized as the touch-sensitive screen 110 and finger(s) of the user is(are) utilized as the pointing device in the following embodiments in which an interaction signal between a touched finger(s) and a control area touched by the finger(s) are determined by detecting the number of touched fingers, wherein a single finger is utilized to decrease the value of the parameter, while two fingers are utilized to increase the value of the parameter within the control area, but it is not limited thereto. Meanwhile, the electronic device 100 is executing a multimedia playing program.

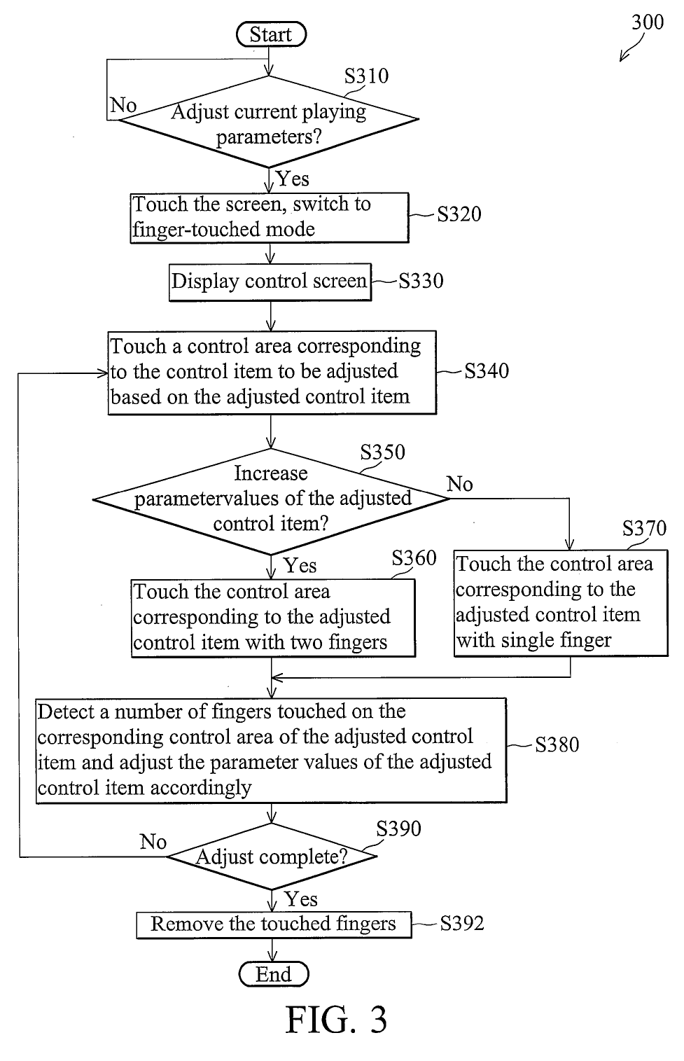

FIG. 3 is a flowchart illustrating an embodiment of a control method according to the invention. Referring to FIGS. 1 and 3, it is first determined whether the playing parameters of the executed multimedia playing program are to be adjusted (step S310). If none of the playing parameters are to be adjusted (No in step S310), the process goes back to step 310 to continually perform the determination operation. If so (Yes in step S310), the touch-sensitive screen 110 is touched by the user such that it is switched to and operated in a finger-touched mode (step S320). After switching to the finger-touched mode, a control screen is displayed on the touch-sensitive screen 110 (step S330). The control screen includes all control items that can be adjusted under the program being operated, in which each control item has a corresponding control area within the control screen (referring to FIG. 5A). Then, based on the desired control item to be adjusted, a control area corresponding to the control item being adjusted is touched by the user (step S340). Thereafter, it is determined whether to increase the parameters of the adjusted control item (step S350). If so, the control area corresponding to the adjusted control item is touched by the user with two fingers (step S360). If the parameters of the adjusted control item are to be decreased (No is step S350), the control area corresponding to the adjusted control item is touched by the user with a single finger (step S370). Then, the number of fingers (i.e. single finger or two fingers) touching the corresponding control area of the adjusted control item are detected and the parameter of the adjusted control item is adjusted according to the number of detected touched fingers (step S380).

It is then determined whether the adjustment is finished (step S390). If more adjustments are required, steps S340-S380 re-perform the aforementioned adjustment process corresponding to the additional adjusting instructions. If the adjustment is finished (Yes in step S390), the touched finger(s) are removed from the screen for indicating that the adjustment operation has been completed (step S392). Next, the control screen will automatically disappear and the touch-sensitive screen 110 will switch out off the finger-touched mode after the user removes the touched finger(s) for a predetermined period of time. The touch-sensitive screen 110 will again be operated in the finger-touched mode, once a finger touching the touch-sensitive screen 110 has been detected.

FIGS. 5A and 5B are schematics showing embodiments of a signal input method for illustrating how a parameter of the control item is adjusted by using different number of touched fingers according to the invention. Referring to FIGS. 5A, 5B and 1, as previously discussed, the control screen 500 is divided into four control areas A-D in which control area B has an indicator I2 indicating control item “Volume” for volume control. In other words, the volume level will be adjusted if any touch within the control area B has been detected. FIG. 5A shows an embodiment illustrating a way to decrease the level of the volume by touching with a single finger, while FIG. 5B shows an embodiment illustrating a way to increase the level of the volume by touching with two fingers.

When a user attempts to adjust the level of the volume during operation of a multimedia playing program, the touch-sensitive screen 110 is touched thereby, and enters into the finger-touched mode. The control screen 500 is then displayed on the touch-sensitive screen 110. The control screen 500 comprises all control items that can be adjusted in which each control item has a corresponding control area. As shown in FIG. 5A, the adjustable control items may comprise a brightness control, a volume control, a channel selection control (i.e. increase/decrease selected channel) and a Speed control for display for controlling the display speed. In this embodiment, the control item to be adjusted is the control item “Volume” which corresponds to control area B. Therefore, a user touches any position within the control area B with his/her finger(s) to input adjusting instructions. The control area B is touched with a single finger if the user desires to decrease the level of the volume as shown in FIG. 5A. Similarly, the control area B is touched with two fingers if the user desires to increase the level of the volume as shown in FIG. 5B.

The number of touch points touched on the control area B is then detected by the detection unit 120 to obtain the number of touched fingers. For example, a single finger is determined to have touched the control area B if only one touch point P1 has been detected (see FIG. 5A) and two fingers are determined to have touched the control area B if two touch points P2 and P3 have been detected (see FIG. 5B). Then, the detection unit 120 sends information containing the number of detected touched fingers and which control area has been touched to the processing unit 130. Accordingly, the analyzing unit 132 of the processing unit 130 analyzes the number of the touched fingers and converts the analyzed result to adjusting instructions based on a predefined rule. The adjusting unit 134 of the processing unit 130 then adjusts the level of the volume according to the adjusting instructions converted by the analyzing unit 132.

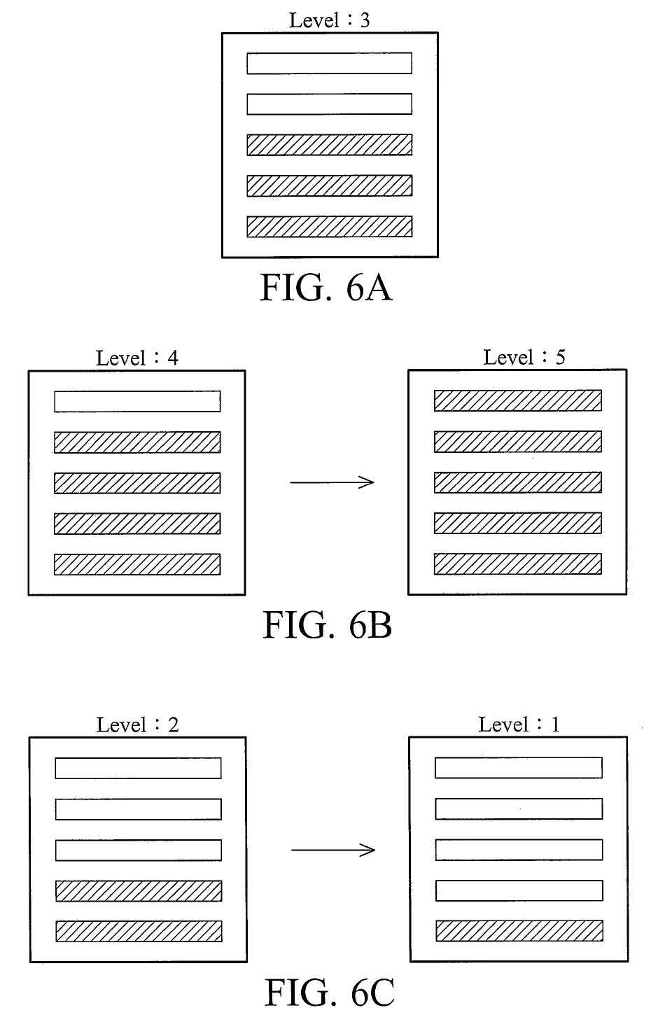

FIGS. 6A to 6C are schematics showing embodiments of volume control before and after adjusting the level of the volume according to the invention. FIGS. 6A to 6C illustrate the adjusting process for adjusting the level of the volume. It is assumed that the larger the level number of the volume is, the louder the volume. For example, the volume for level 5 of the volume is louder than that for level 4 of the volume. FIG. 6A shows that the level of the volume before adjustment is level 3. If the user feels that the volume is too low, he/she can touch the control area B with two fingers to send instructions to increase the level of the volume (see FIG. 5B), such that the level of the volume will be increased by one, that is, the level of the volume is adjusted from level 3 to level 4. If the user still feels that the volume is too low, he/she can once again touch the control area B with two fingers to send instructions to increase the level of the volume such that the level of the volume will be further increased from level 4 to level 5 as shown in FIG. 6B.

Similarly, if the user feels that the volume is too loud, he/she can touch the control area B with a single finger to send instructions to decrease the level of the volume (see FIG. 5A), such that the level of the volume will be decreased by one, that is, the level of the volume is adjusted from level 3 to level 2. If the user still feels that the volume is too loud after the above adjustment, he/she can once again touch the control area B with a single finger to send instructions to decrease the level of the volume such that the level of the volume will be further decreased from level 2 to level 1 as shown in FIG. 6C.

In summary, with the electronic device and related input method of the invention, the user can send adjusting instructions by intuitively utilizing control of inputted fingers or touched forces, to perform the adjustment operation within a wider control area such that the required adjustment can be easily performed. Additionally, the electronic device and related input method of the invention effectively simplifies use for users when performing required adjustments and improves user convenience.

Additionally, in other embodiments, by holding and pressing a specific key (e.g. function key [Fn]) and then directly touching the screen with a finger(s), the screen can be operated in a finger-touched mode and perform parameter switching for a single control item, such as switching the displayed screen, to replace the original fast key functions.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. An input method for use in an electronic device having a touch-sensitive screen, comprising:
(a) receiving an input signal;
(b) displaying at least one control item on the touch-sensitive screen, wherein the control item has a corresponding control area within the touch-sensitive screen;
(c) detecting whether a confirmation input signal has been inputted to the corresponding control area of the touch-sensitive screen; and
(d) adjusting a parameter of the control item according to the confirmation input signal when the confirmation input signal has been detected.

2. The input method of claim 1, wherein the step of detecting whether the confirmation input signal has been inputted to the corresponding control area of the touch-sensitive screen further comprises:
detecting whether a plurality of input signals have been touched on the corresponding control area of the touch-sensitive screen.

3. The input method of claim 2, further comprising:
decreasing said parameter when said signal responsive to a corresponding area has been detected.

4. The input method of claim 2, further comprising:
increasing said parameter when said signal responsive to a corresponding area has been detected.

5. The input method of claim 2, further comprising:
setting the parameter of the control item according to the amount of detected input signals.

6. The input method of claim 2, further comprising:
converting the confirmation input signal to an adjustment signal for adjusting the parameter of the control item based on a specific rule.

7. The input method of claim 1, further comprising:
detecting whether the signal touched on the corresponding control area is a lightly pressed signal or a heavily pressed signal.

8. The input method of claim 7, further comprising:
respectively decreasing or increasing the parameter of the control item according to whether the signal touched within the corresponding control area is a lightly pressed signal or a heavily pressed signal.

9. The input method of claim 1, wherein the confirmation input signal is an interactive signal representing an interaction between the corresponding control area and finger(s), wherein the interactive signal corresponds to a touch-sensitive screen type.

10. The input method of claim 1, wherein the step of displaying at least one control item on the touch-sensitive screen further comprises:
providing a control screen showing the control item and the corresponding control area.

11. The input method of claim 10, wherein the control screen further provides a plurality of control areas each having an indication symbol for indicating a control item corresponding thereto.

12. The input method of claim 1, wherein the control item comprises at least one of a volume control, a brightness control, a channel selection control and a speed control for display.

13. An electronic device, comprising:
a touch-sensitive screen operable in a first mode, displaying a control screen having at least one control item thereon, wherein the control item has a corresponding control area within the control screen;
a detection unit, detecting whether a pointing device is touching the touch-sensitive screen and detecting the interaction between the pointing device and the corresponding control area; and
a processing unit,
wherein when an input signal inputted to the touch-sensitive screen is detected by the detection unit, the processing unit adjusts a parameter of the control item according to the input signal and an interaction signal of the corresponding control area detected by the detection unit.

14. The electronic device of claim 13, wherein the processing unit further comprises:
an analyzing unit, converting the interaction signal to an adjustment signal for adjusting the parameter of the control item based on a specific rule; and
an adjusting unit, adjusting the parameter of the control item according to the adjustment signal generated by the analyzing unit.

15. The electronic device of claim 13, wherein the input signal is generated by a finger(s) or a fingertip(s) of a user or a stylus.

16. The electronic device of claim 15, wherein the processing unit further adjusts the parameter of the control item according to whether the input signal detected by the detection unit is a lightly pressed signal or a heavily pressed signal, when the pointing device is finger(s) of the user.

17. The electronic device of claim 16, wherein the processing unit further decreases the parameter of the control item when an input signal within the control area is detected by the detection unit and increases the parameter of the control item when a plurality of input signals within the control area are detected by the detection unit.

18. The electronic device of claim 16, wherein the processing unit further decreases the parameter of the control item when the input signal within the control area detected by the detection unit is a lightly pressed signal and increases the parameter of the control item when the input signal within the control area detected by the detection unit is a heavily pressed signal.

19. The electronic device of claim 13, wherein the touch-sensitive screen at least comprise a multi-touch panel and a pressure-sensitive touch panel.

20. An input method for use in an electronic device having a touch-sensitive display, comprising:
providing a control screen, wherein the control screen has a plurality of control items each having a corresponding control area within the control screen;
detecting whether an input signal of a first control area corresponding to a first control item of the control items has been generated; and
determining an attribute of the input signal and accordingly adjusting a parameter of the first control item.

21. The input method of claim 20, wherein the determining and adjusting steps further comprises:
decreasing the parameter of the first control item when detecting that an input signal has been inputted to the first control area; and
increasing the parameter of the first control item when detecting that a plurality of input signals have been inputted to the first control area.

22. The input method of claim 20, wherein the determining and adjusting steps further comprises:
decreasing the parameter of the first control item when detecting that a lightly pressed signal has been inputted to the first control area; and
increasing the parameter of the first control item when detecting that a heavily pressed signal has been inputted to the first control area.

23. The input method of claim 20, wherein the control item comprises at least one of a volume control, a brightness control, a channel selection control and a speed control for display.
